(19) United States
(12) Patent Application Publication
(10) Pub. No.: US 2011/0013542 A1
(43) Pub. Date: Jan. 20, 2011

(54) METHOD AND BASE STATION FOR ALLOCATING DEDICATED RANDOM ACCESS RESOURCE

(75) Inventors: Bin Yu, Shenzhen (CN); Peng Hao, Shenzhen (CN); Zhongda Du, Shenzhen (CN); Kexue Lu, Shenzhen (CN)

Correspondence Address: Neal, Gerber & Eisenberg LLP, C/O Patent Administrator, Two North LaSalle Street, Suite 1700, Chicago, IL, 60602, US

(73) Assignee: Zte Corporation

(21) Appl. No.: 12/920,456

(22) PCT Filed: Sep. 4, 2009
(86) PCT No.: PCT/CN2009/073769

§ 371 Date: Aug. 31, 2010

(30) Foreign Application Priority Data
Sep. 22, 2008 (CN) 200810166217.4

(51) Int. Cl. H04J 3/00

(52) U.S. Cl. 370/280

(57) ABSTRACT

The present invention discloses a method and a base station for allocating the dedicated random access resource. In the method, first, the base station allocates the dedicated random access preamble to the user equipment (UE), and allocates the predetermined physical random access channel (PRACH) to which the dedicated random access preamble corresponds in the allocated radio frame; then, the base station transmits the signaling to the UE, wherein, the signaling includes the time domain information and the frequency domain information of the predetermined PRACH. The technical solution provided by the present invention can allocate the same dedicated random access preamble for different PRACH channels to different UEs, and can improve the utilization efficiency of the dedicated random access preamble.

### TECHNICAL FIELD

The present invention relates to the technical field of mobile communications, particularly to a method and a base station for allocating the dedicated random access resource in non-contention based random access.

### BACKGROUND

In a long term evolution (LTE) frequency division duplex (FDD)/time division duplex (TDD) system, there are two random access procedures which are contention based random access procedure and non-contention based random access procedure. The non-contention based random access procedure is mainly used for handover and downlink data arrival during out-of-synchronism of the user equipment (UE). As shown in FIG. 1, the non-contention based random access procedure mainly comprises the following steps:

Step S101: downlink dedicated high layer signaling allocates the dedicated random access preamble used for non-contention based random access.

Specifically, this step may include the following steps:

Step 1: a base station (eNodeB) allocates a dedicated random access preamble used for non-contention based random access to a UE. This preamble is different from the preamble used for contention random access in a broadcast message notice.

Step 2: the base station allocates a signaling mode of the dedicated random access preamble to the UE; if this access procedure is used for handover, step 2 may be: the target cell generates a handover command, which is transmitted to the UE through the source base station, containing the random access preamble information for handover; if this access procedure is used during out-of-synchronism of the UE, step 2 may be: the base station allocates a dedicated random access preamble to the UE through a physical downlink control channel (PDCCH). This dedicated random access preamble is used in the scenario in which the downlink data have arrived, while the UE is in an out-of-synchronism state.

Step S103: the UE transmits the allocated dedicated random access preamble over an uplink physical random access channel (PRACH).

Step S105: the UE receives the random access response message of the base station over a downlink shared channel (DL-SCH).

In an LTE system, each PRACH channel has 64 available preambles. Some of the preambles are reserved for non-contention based random access procedure, i.e. reserved as dedicated preambles, while the preambles the UE transmits in contention based random access procedure will not be selected from these preambles. As the LTE system may be configured with a plurality of PRACH channels in a radio frame, while in the foregoing processing flow, the base station does not allocate dedicated random access resource for a certain UE, in other words, the PRACH to which the preambles allocated by the base station to this UE correspond may be a plurality of the foregoing PRACH channels. Therefore, even on different PRACH channels, different UEs can not use the same dedicated preamble, thereby resulting in low utilization efficiency of dedicated preambles.

### SUMMARY

For this reason, the present invention provides a method for allocating dedicated random access resource to solve the problem of low utilization efficiency in the prior art.

In order to realize the object of the present invention, a method for allocating the dedicated random access resource is provided according to one aspect of the present invention.

The method for allocating dedicated random access resource according to the present invention includes: a base station allocates a dedicated random access preamble to a UE, and allocates a predetermined PRACH to which the dedicated random access preamble corresponds in a radio frame; and the base station transmits signaling to the UE, wherein, the signaling includes time domain information and frequency domain information of the predetermined PRACH.

In order to realize the object of the present invention, a base station is provided according to another aspect of the present invention.

The base station according to the present invention comprises: an allocation module and a transmission module. The allocation module is used to allocate the dedicated random access preamble to the UE and allocate the PRACH to which the dedicated random access preamble corresponds; and the transmission module is used to transmit signaling to the UE; wherein, the signaling includes time domain information and frequency domain information of the foregoing PRACH.

By at least one of the foregoing solutions of the present invention, the base station allocates the dedicated random access preamble to the UE, and allocates the PRACH to which the dedicated random access preamble corresponds; and the time domain and the frequency domain of the PRACH to which the dedicated random access preamble allocated to the UE corresponds are informed through signaling. As a result, the same preamble may be allocated for different PRACH channels to different UEs, thereby improving the utilization efficiency of the dedicated preambles.

Other characteristics and advantages of the present invention will be illustrated in the subsequent Description, or partially become obvious through the Description or understood through implementation of the present invention. The object and other advantages of the present invention may be realized and acquired through the structures particularly indicated in the Description, Claims and Drawings.

### BRIEF DESCRIPTION OF THE DRAWINGS

The drawings are intended to provide further understanding of the present invention and constitute a part of the Description. They are intended to explain the present invention in conjunction with the embodiments of the present invention and not to limit the present invention. Among the drawings:

FIG. 1 is a flow chart of non-contention based random access according to the prior art;

FIG. 2A is a schematic diagram of Type 1 frame structure in the embodiment of the present invention;

FIG. 2B is a schematic diagram of Type 2 frame structure in the embodiment of the present invention;

FIG. 3 is a schematic diagram illustrating the structure of PRACH in the embodiment of the present invention;

FIG. 4 is a flow chart of the method for allocating the dedicated random access resource according to the embodiment of the present invention;

FIG. 5 is a flow chart of non-contention based random access in the embodiment of the present invention;

FIG. 6A is a schematic diagram of the time-frequency domain locations of PRACH in the embodiment of the present invention;

FIG. 6B is another schematic diagram of the time-frequency domain locations of PRACH in the embodiment of the present invention; and

FIG. 7 is a block diagram illustrating the structure of the base station according to the embodiment of the present invention.

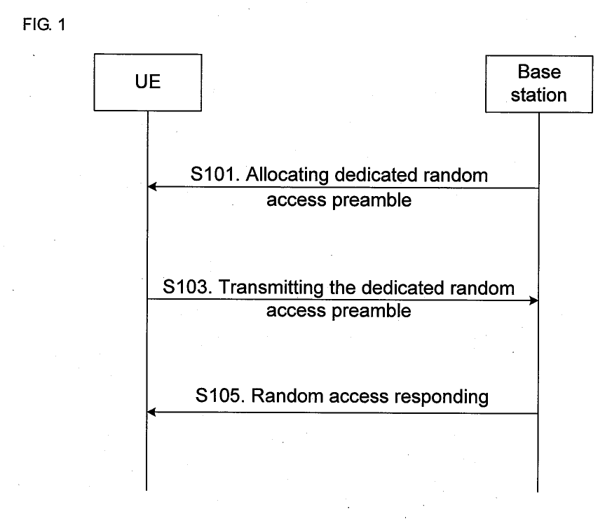

### DETAILED DESCRIPTION

### Function Overview

As described above, in order to address the problem of low utilization efficiency of preambles in the prior art, the present invention provides a solution for allocating dedicated random access resource. In this solution, when the base station allocates the dedicated random access preamble to the UE, it allocates PRACH channels for this dedicated random access preamble, i.e. the base station allocates random access resource to this UE, and the time domain and the frequency domain where the allocated PRACH locates are sent to the UE through the dedicated signaling, to notify the UE that which PRACH channel in the radio frame the dedicated random access preamble allocated to the UE should be transmitted over. Consequently, when the dedicated random access preamble is restricted, the chance to use non-contention based random access procedure will be increased, i.e. different UEs may use the same dedicated random access preamble over different PRACH channels.

If without conflict, the embodiments of the present invention and the characteristics in the embodiments may be combined.

The preferred embodiments of the present invention are described below in conjunction with the drawings. It should be understood that the preferred embodiments described here are intended to illustrate and not to limit the present invention.

In order to more easily understand the present invention, the frame structure, preamble format, random access configuration, and frequency domain multiplexing and mapping of the LTE system will be briefly introduced below at first.

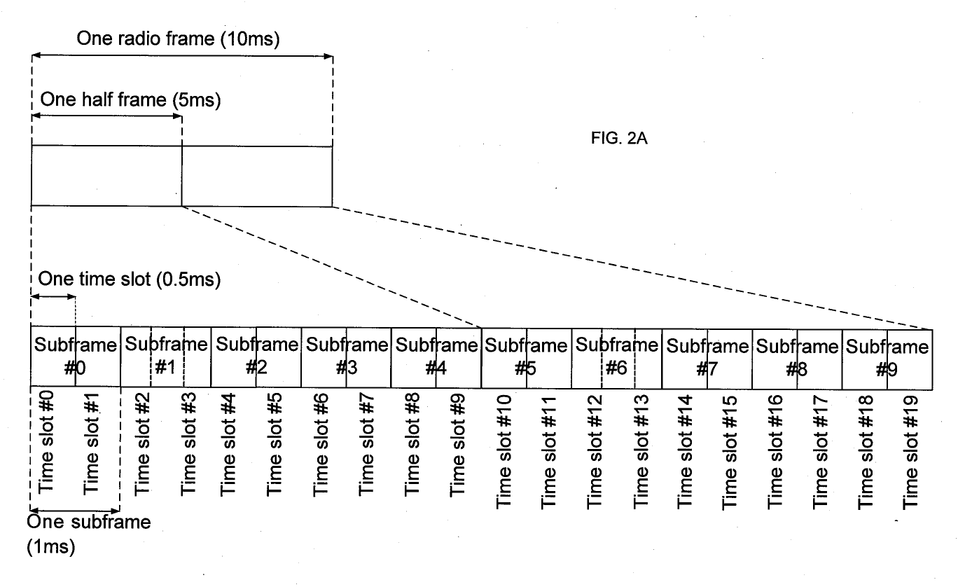

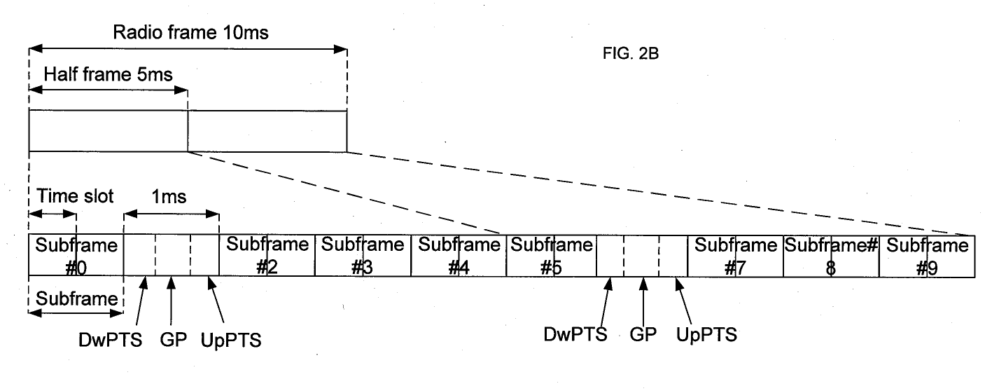

In the LTE system, there are two types of the frame structure, which are Type 1 and Type 2. The Type 1 frame structure, which is shown in FIG. 2A, may be applied to an FDD mode. The Type 2 frame structure, which is shown in FIG. 2B, may be applied to a TDD mode. As shown in FIG. 2A or FIG. 2B, in the LTE frame structure, a radio frame with length of 10 ms is divided into two half frames with length of 5 ms each, and each half frame consists of five subframes with length of 1 ms each. Except the special subframes in the Type 2 frame structure, other subframes are all constituted by two time slots with length of 0.5 ms each. The special subframes in the Type 2 frame structure comprise three special time slots which are a downlink pilot time slot (DwPTS), a guard period (GP) and an uplink pilot time slot (UpPTS). In the LTE frame structure, the duration of an uplink/downlink symbol is 66.7 us, and each uplink/downlink symbol has a cyclic prefix (CP). In the LTE, two types of the CP are defined, which are a normal CP and an extended CP. For the normal CPs with length of 5.21 us and 4.69 us, a time slot contains 7 uplink/downlink symbols. The length of the CP of the first symbol is 5.21 us and the length of the CP of the rest 6 symbols is 4.69 us; for the extended CP with length of 16.67 us, a time slot contains 6 uplink/downlink symbols.

In the Type 2 frame structure, subframe 0, subframe 5 and DwPTS are always used for downlink transmission, and subframe 2 and UpPTS are always used for uplink transmission. When there are 2 downlink-to-uplink switch-points within 10 ms, subframe 7 will also be used for uplink transmission. Whether other subframes are used for uplink transmission or downlink transmission is determined by the uplink and downlink configurations. The current uplink and downlink proportional configuration set is shown in Table 1. There are 7 types of the uplink and downlink configurations. Wherein, D denotes the subframe used for downlink transmission, U denotes the subframe used for uplink transmission, and S denotes the special subframe, containing DwPTS, GP and UpPTS. In the Type 1 frame structure, the uplink and downlink adopt different frequency resources, so the uplink and downlink always have a same number of subframes.

TABLE 1
proportional configuration set of the
Uplink and downlink in the LTE TDD

| Configu- | | | | | | | | | | | |
|---|---|---|---|---|---|---|---|---|---|---|---|
| ration | Switch-point | Subframe number | | | | | | | | | |
| No. | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

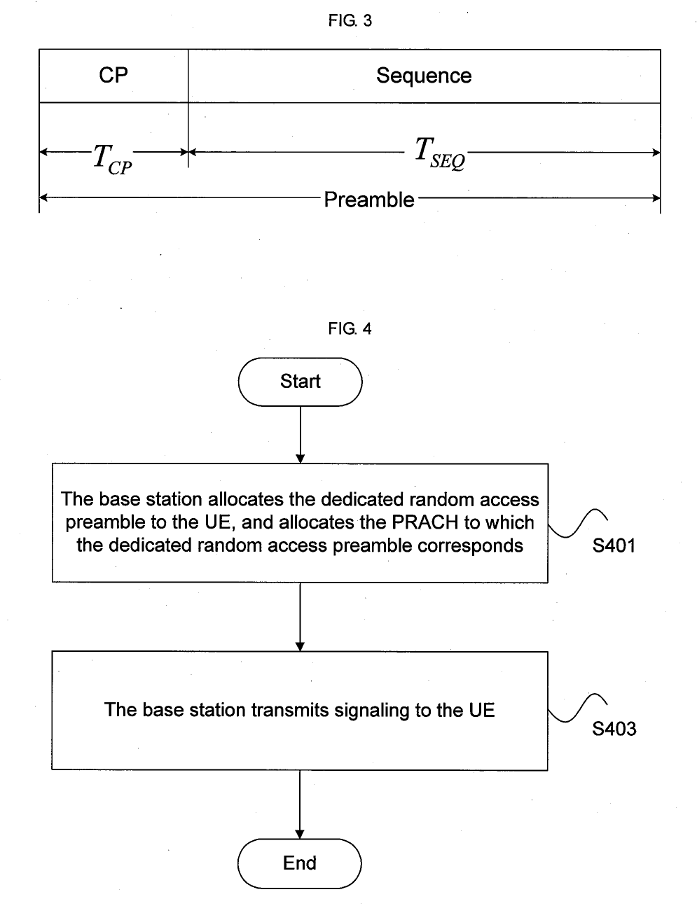

The structure of the PRACH channel in the LTE system is shown in FIG. 3. A preamble consists of a CP and a sequence. The length of the CP and/or the sequence varies with the preamble format. The sorts of the preamble formats supporting both the TDD mode and the FDD mode in the current LTE system are listed in Table 2.

TABLE 2
Preamble formats

| Preamble format | T_{CP} | T_{SEQ} |
|---|---|---|
| 0 | 3168 · Tₛ | 24576 · Tₛ |
| 1 | 21024 · Tₛ | 24576 · Tₛ |
| 2 | 6240 · Tₛ | 2 · 24576 · Tₛ |
| 3 | 21024 · Tₛ | 2 · 24576 · Tₛ |
| 4 | 448 · Tₛ | 4096 · Tₛ |

(This format is applied to TDD mode only)

Among the foregoing preamble formats, preamble formats 0-3 are transmitted in the ordinary uplink subframes of a TDD or FDD system, while preamble format 4 is transmitted in an UpPTS of TDD system, specifically:

preamble format 0 is transmitted in an ordinary uplink subframe;

preamble formats 1 or 2 are transmitted in two ordinary uplink subframes;

preamble format 3 is transmitted in three ordinary uplink subframes; and

preamble format 4 is transmitted in the UpPTS.

In the frequency domain, each of the foregoing PRACH channels occupies 6 resource blocks (RB). Each RB contains 12 sub-carriers. The bandwidth of each sub-carrier is 15 kHz. The random access configurations of the LTE FDD and TDD systems are shown in Table 3 and Table 4, respectively.

TABLE 3
Random access configurations of the LTE FDD

| PRACH | | | |
|---|---|---|---|
| Configuration | Preamble | System frame | Subframe |
| Index | format | number | number |
| 0 | 0 | Even | 1 |
| 1 | 0 | Even | 4 |
| 2 | 0 | Even | 7 |
| 3 | 0 | Any | 1 |
| 4 | 0 | Any | 4 |
| 5 | 0 | Any | 7 |
| 6 | 0 | Any | 1, 6 |
| 7 | 0 | Any | 2, 7 |
| 8 | 0 | Any | 3, 8 |
| 9 | 0 | Any | 1, 4, 7 |
| 10 | 0 | Any | 2, 5, 8 |
| 11 | 0 | Any | 3, 6, 9 |
| 12 | 0 | Any | 0, 2, 4, 6, 8 |
| 13 | 0 | Any | 1, 3, 5, 7, 9 |
| 14 | 0 | Any | 0, 1, 2, 3, 4, |
| | | | 5, 6, 7, 8, 9 |
| 15 | 0 | Even | 9 |
| 16 | 1 | Even | 1 |
| 17 | 1 | Even | 4 |
| 18 | 1 | Even | 7 |
| 19 | 1 | Any | 1 |
| 20 | 1 | Any | 4 |
| 21 | 1 | Any | 7 |
| 22 | 1 | Any | 1, 6 |
| 23 | 1 | Any | 2, 7 |
| 24 | 1 | Any | 3, 8 |
| 25 | 1 | Any | 1, 4, 7 |
| 26 | 1 | Any | 2, 5, 8 |
| 27 | 1 | Any | 3, 6, 9 |
| 28 | 1 | Any | 0, 2, 4, 6, 8 |
| 29 | 1 | Any | 1, 3, 5, 7, 9 |
| 30 | N/A | N/A | N/A |
| 31 | 1 | Even | 9 |
| 32 | 2 | Even | 1 |
| 33 | 2 | Even | 4 |
| 34 | 2 | Even | 7 |
| 35 | 2 | Any | 1 |
| 36 | 2 | Any | 4 |
| 37 | 2 | Any | 7 |
| 38 | 2 | Any | 1, 6 |
| 39 | 2 | Any | 2, 7 |
| 40 | 2 | Any | 3, 8 |
| 41 | 2 | Any | 1, 4, 7 |
| 42 | 2 | Any | 2, 5, 8 |
| 43 | 2 | Any | 3, 6, 9 |
| 44 | 2 | Any | 0, 2, 4, 6, 8 |
| 45 | 2 | Any | 1, 3, 5, 7, 9 |
| 46 | N/A | N/A | N/A |
| 47 | 2 | Even | 9 |
| 48 | 3 | Even | 1 |
| 49 | 3 | Even | 4 |
| 50 | 3 | Even | 7 |
| 51 | 3 | Any | 1 |
| 52 | 3 | Any | 4 |
| 53 | 3 | Any | 7 |
| 54 | 3 | Any | 1, 6 |
| 55 | 3 | Any | 2, 7 |
| 56 | 3 | Any | 3, 8 |
| 57 | 3 | Any | 1, 4, 7 |
| 58 | 3 | Any | 2, 5, 8 |
| 59 | 3 | Any | 3, 6, 9 |
| 60 | N/A | N/A | N/A |
| 61 | N/A | N/A | N/A |
| 62 | N/A | N/A | N/A |
| 63 | 3 | Even | 9 |

TABLE 4
Random access configurations of the LTE TDD

| PRACH | | Density | |
|---|---|---|---|
| Configuration | Preamble | Per 10 ms | Version |
| Index | Format | (D_{RA}) | (r_{RA}) |
| 0 | 0 | 0.5 | 0 |
| 1 | 0 | 0.5 | 1 |
| 2 | 0 | 0.5 | 2 |
| 3 | 0 | 1 | 0 |
| 4 | 0 | 1 | 1 |
| 5 | 0 | 1 | 2 |
| 6 | 0 | 2 | 0 |
| 7 | 0 | 2 | 1 |
| 8 | 0 | 2 | 2 |
| 9 | 0 | 3 | 0 |
| 10 | 0 | 3 | 1 |
| 11 | 0 | 3 | 2 |
| 12 | 0 | 4 | 0 |
| 13 | 0 | 4 | 1 |
| 14 | 0 | 4 | 2 |
| 15 | 0 | 5 | 0 |
| 16 | 0 | 5 | 1 |
| 17 | 0 | 5 | 2 |
| 18 | 0 | 6 | 0 |
| 19 | 0 | 6 | 1 |
| 20 | 1 | 0.5 | 0 |
| 21 | 1 | 0.5 | 1 |
| 22 | 1 | 0.5 | 2 |
| 23 | 1 | 1 | 0 |
| 24 | 1 | 1 | 1 |
| 25 | 1 | 2 | 0 |
| 26 | 1 | 3 | 0 |
| 27 | 1 | 4 | 0 |
| 28 | 1 | 5 | 0 |
| 29 | 1 | 6 | 0 |
| 30 | 2 | 0.5 | 0 |
| 31 | 2 | 0.5 | 1 |
| 32 | 2 | 0.5 | 2 |
| 33 | 2 | 1 | 0 |
| 34 | 2 | 1 | 1 |
| 35 | 2 | 2 | 0 |
| 36 | 2 | 3 | 0 |
| 37 | 2 | 4 | 0 |
| 38 | 2 | 5 | 0 |
| 39 | 2 | 6 | 0 |
| 40 | 3 | 0.5 | 0 |
| 41 | 3 | 0.5 | 1 |
| 42 | 3 | 0.5 | 2 |
| 43 | 3 | 1 | 0 |
| 44 | 3 | 1 | 1 |
| 45 | 3 | 2 | 0 |
| 46 | 3 | 3 | 0 |
| 47 | 3 | 4 | 0 |
| 48 | 4 | 0.5 | 0 |
| 49 | 4 | 0.5 | 1 |
| 50 | 4 | 0.5 | 2 |
| 51 | 4 | 1 | 0 |
| 52 | 4 | 1 | 1 |
| 53 | 4 | 2 | 0 |
| 54 | 4 | 3 | 0 |
| 55 | 4 | 4 | 0 |
| 56 | 4 | 5 | 0 |
| 57 | 4 | 6 | 0 |

The configuration index (PRACH Configuration Index) of each random access corresponds to the combination of a set of configuration parameters and indicates the following content: PRACH format, PRACH density (the number of PRACH channels configured in each radio frame) and the time domain location transmitted by each PRACH (in the FDD mode, this index directly corresponds to the initial subframe number of the PRACH-time-domain) or the version number configured for the time domain (in the TDD mode, this index indicates the version number of a few different mapping modes of the time domain). The configuration index is informed to the UE through a broadcast message. For the LTE FDD system, there is one PRACH channel at most in the frequency domain, and a radio frame may contain 10 PRACH channels at most, which are all divided in the time domain. The concrete time domain location is described in Table 3. In the frequency domain location, all PRACH channels are same and configured by the base station in a unified way. For the LTE TDD system, a radio frame may contain 6 PRACH channels at most and the mapping of the PRACH channel adopts a way of first time domain then frequency domain. When the resource of the time domain is not enough to carry the configured PRACH density through time domain multiplexing on the precondition that the PRACH does not overlap in the time domain, a plurality of the PRACH channels may be multiplexed in the frequency domain, so the frequency domain may contain 6 PRACH channels at most.

In the LTE TDD system, corresponding to the PRACH configuration in Table 4, under the different uplink and downlink-configurations as shown in Table 1, the mapping locations of the needed PRACH channels in the time domain of respective uplink resource are shown in Table 5. The expression format of the quaternion in the table is (f_{RA}, t_{RA}⁰, t_{RA}¹, t_{RA}²), indicating a specific random access physical resource or in other words, indicating a specific PRACH channel, wherein f_{RA} denotes the index of a specific PRACH channel in the frequency domain at the time domain location designated by (t_{RA}⁰, t_{RA}¹, t_{RA}²), or in other words, f_{RA} denotes a specific PRACH channel in the frequency domain at this time domain location, f_{RA}ε{0, 1, 2, 3, 4, 5}. t_{RA}⁰=0, 1, 2 indicates that a specific PRACH channel is re-transmitted at the intra-frame location indicated by (t_{RA}¹, t_{RA}²) in all radio frames, or only in even radio frames or only in odd radio frames. t_{RA}¹=0, 1 indicates that a specific PRACH corresponds to the first half frame or the second half frame in a radio frame. For the PRACH channel using preamble formats 0-3, t_{RA}² denotes the serial number of the uplink subframe where the starting point of time-domain mapping of the PRACH channel lies in the first half frame or the second half frame. This serial number is numbered by starting from 0 in order. 0 corresponds to the first uplink subframe in each half frame except the UpPTS; the PRACH channel using preamble format 4 is always configured to the UpPTS, and t_{RA}² in the table is expressed with (*).

TABLE 5
Mapping of the random access channels of the LTE TDD in the time domain

| PRACH | | | | | | | |
|---|---|---|---|---|---|---|---|
| Configuration | Uplink and downlink proportional configuration (See Table 1) | | | | | | |
| Index | 0 | 1 | 2 | 3 | 4 | 5 | 6 |
| 0 | (0, 1, 0, 2) | (0, 1, 0, 1) | (0, 1, 0, 0) | (0, 1, 0, 2) | (0, 1, 0, 1) | (0, 1, 0, 0) | (0, 1, 0, 2) |
| 1 | (0, 2, 0, 2) | (0, 2, 0, 1) | (0, 2, 0, 0) | (0, 2, 0, 2) | (0, 2, 0, 1) | (0, 2, 0, 0) | (0, 2, 0, 2) |
| 2 | (0, 1, 1, 2) | (0, 1, 1, 1) | (0, 1, 1, 0) | (0, 1, 0, 1) | (0, 1, 0, 0) | N/A | (0, 1, 1, 1) |
| 3 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| 4 | (0, 0, 1, 2) | (0, 0, 1, 1) | (0, 0, 1, 0) | (0, 0, 0, 1) | (0, 0, 0, 0) | N/A | (0, 0, 1, 1) |
| 5 | (0, 0, 0, 1) | (0, 0, 0, 0) | N/A | (0, 0, 0, 0) | N/A | N/A | (0, 0, 0, 1) |
| 6 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| | (0, 0, 1, 2) | (0, 0, 1, 1) | (0, 0, 1, 0) | (0, 0, 0, 1) | (0, 0, 0, 0) | (1, 0, 0, 0) | (0, 0, 1, 1) |
| 7 | (0, 0, 0, 1) | (0, 0, 0, 0) | N/A | (0, 0, 0, 0) | N/A | N/A | (0, 0, 0, 1) |
| | (0, 0, 1, 1) | (0, 0, 1, 0) | | (0, 0, 0, 2) | | | (0, 0, 1, 0) |
| 8 | (0, 0, 0, 0) | N/A | N/A | (0, 0, 0, 1) | N/A | N/A | (0, 0, 0, 0) |
| | (0, 0, 1, 0) | | | (0, 0, 0, 0) | | | (0, 0, 1, 1) |
| 9 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| | (0, 0, 1, 2) | (0, 0, 1, 1) | (0, 0, 1, 0) | (0, 0, 0, 1) | (0, 0, 0, 0) | (1, 0, 0, 0) | (0, 0, 1, 1) |
| | (0, 0, 0, 1) | (0, 0, 0, 0) | (1, 0, 0, 0) | (0, 0, 0, 0) | (1, 0, 0, 1) | (2, 0, 0, 0) | (0, 0, 0, 1) |
| 10 | (0, 0, 1, 1) | (0, 0, 1, 0) | (0, 0, 1, 0) | N/A | (0, 0, 0, 0) | N/A | (0, 0, 1, 0) |
| | (0, 0, 0, 0) | (0, 0, 0, 1) | (0, 0, 0, 0) | | (0, 0, 0, 1) | | (0, 0, 0, 0) |
| | (0, 0, 1, 0) | (0, 0, 1, 1) | (1, 0, 1, 0) | | (1, 0, 0, 0) | | (0, 0, 0, 2) |
| 11 | N/A | (0, 0, 0, 0) | N/A | N/A | N/A | N/A | (0, 0, 1, 1) |
| | | (0, 0, 1, 0) | | | | | (0, 0, 0, 1) |
| | | (0, 0, 0, 1) | | | | | (0, 0, 1, 0) |
| 12 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| | (0, 0, 1, 2) | (0, 0, 1, 1) | (0, 0, 1, 0) | (0, 0, 0, 1) | (0, 0, 0, 0) | (1, 0, 0, 0) | (0, 0, 1, 1) |
| | (0, 0, 0, 1) | (0, 0, 0, 0) | (1, 0, 0, 0) | (0, 0, 0, 0) | (1, 0, 0, 1) | (2, 0, 0, 0) | (0, 0, 0, 1) |
| | (0, 0, 1, 1) | (0, 0, 1, 0) | (1, 0, 1, 0) | (1, 0, 0, 2) | (1, 0, 0, 0) | (3, 0, 0, 0) | (0, 0, 1, 0) |
| 13 | (0, 0, 0, 0) | N/A | N/A | (0, 0, 0, 1) | N/A | N/A | (0, 0, 0, 0) |
| | (0, 0, 1, 0) | | | (0, 0, 0, 0) | | | (0, 0, 0, 2) |
| | (0, 0, 0, 2) | | | (0, 0, 0, 2) | | | (0, 0, 1, 1) |
| | (0, 0, 1, 2) | | | (1, 0, 0, 1) | | | (0, 0, 0, 1) |
| 14 | (0, 0, 0, 1) | N/A | N/A | (0, 0, 0, 0) | N/A | N/A | (0, 0, 1, 0) |
| | (0, 0, 1, 1) | | | (0, 0, 0, 2) | | | (0, 0, 0, 0) |
| | (0, 0, 0, 0) | | | (0, 0, 0, 1) | | | (0, 0, 0, 2) |
| | (0, 0, 1, 0) | | | (1, 0, 0, 0) | | | (0, 0, 1, 1) |
| 15 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| | (0, 0, 1, 2) | (0, 0, 1, 1) | (0, 0, 1, 0) | (0, 0, 0, 1) | (0, 0, 0, 0) | (1, 0, 0, 0) | (0, 0, 1, 1) |
| | (0, 0, 0, 1) | (0, 0, 0, 0) | (1, 0, 0, 0) | (0, 0, 0, 0) | (1, 0, 0, 1) | (2, 0, 0, 0) | (0, 0, 0, 1) |
| | (0, 0, 1, 1) | (0, 0, 1, 0) | (1, 0, 1, 0) | (1, 0, 0, 2) | (1, 0, 0, 0 | (3, 0, 0, 0) | (0, 0, 1, 0) |
| | (0, 0, 0, 0) | (1, 0, 0, 1) | (2, 0, 0, 0) | (1, 0, 0, 1) | (2, 0, 0, 1) | (4, 0, 0, 0) | (0, 0, 0, 0) |
| 16 | (0, 0, 1, 0) | (0, 0, 1, 1) | (0, 0, 1, 0) | (0, 0, 0, 0) | (0, 0, 0, 0) | N/A | N/A |
| | (0, 0, 0, 2) | (0, 0, 0, 0) | (0, 0, 0, 0) | (0, 0, 0, 2) | (0, 0, 0, 1) | | |
| | (0, 0, 1, 2) | (0, 0, 1, 0) | (1, 0, 1, 0 | (0, 0, 0, 1) | (1, 0, 0, 0) | | |
| | (0, 0, 0, 1) | (0, 0, 0, 1) | (1, 0, 0, 0) | (1, 0, 0, 0) | (1, 0, 0, 1) | | |
| | (0, 0, 1, 1) | (1, 0, 1, 1) | (2, 0, 1, 0) | (1, 0, 0, 2) | (2, 0, 0, 0) | | |
| 17 | (0, 0, 0, 0) | (0, 0, 0, 0) | N/A | (0, 0, 0, 1) | N/A | N/A | N/A |
| | (0, 0, 1, 0) | (0, 0, 1, 0) | | (0, 0, 0, 0) | | | |
| | (0, 0, 0, 2) | (0, 0, 0, 1) | | (0, 0, 0, 2) | | | |
| | (0, 0, 1, 2) | (0, 0, 1, 1) | | (1, 0, 0, 1) | | | |
| | (0, 0, 0, 1) | (1, 0, 0, 0) | | (1, 0, 0, 0) | | | |
| 18 | (0, 0, 0, 2) | (0, 0, 0, 1) | (0, 0, 0, 0) | (0, 0, 0, 2) | (0, 0, 0, 1) | (0, 0, 0, 0) | (0, 0, 0, 2) |
| | (0, 0, 1, 2) | (0, 0, 1, 1) | (0, 0, 1, 0) | (0, 0, 0, 1) | (0, 0, 0, 0) | (1, 0, 0, 0) | (0, 0, 1, 1) |
| | (0, 0, 0, 1) | (0, 0, 0, 0) | (1, 0, 0, 0) | (0, 0, 0, 0) | (1, 0, 0, 1) | (2, 0, 0, 0) | (0, 0, 0, 1) |
| | (0, 0, 1, 1) | (0, 0, 1, 0) | (1, 0, 1, 0) | (1, 0, 0, 2) | (1, 0, 0, 0) | (3, 0, 0, 0) | (0, 0, 1, 0) |
| | (0, 0, 0, 0) | (1, 0, 0, 1) | (2, 0, 0, 0) | (1, 0, 0, 1) | (2, 0, 0, 1) | (4, 0, 0, 0) | (0, 0, 0, 0) |
| | (0, 0, 1, 0) | (1, 0, 1, 1) | (2, 0, 1, 0) | (1, 0, 0, 0) | (2, 0, 0, 0) | (5, 0, 0, 0) | (1, 0, 0, 2) |
| 19 | N/A | (0, 0, 0, 0) | N/A | N/A | N/A | N/A | (0, 0, 1, 1) |
| | | (0, 0, 1, 0) | | | | | (0, 0, 0, 1) |
| | | (0, 0, 0, 1) | | | | | (0, 0, 1, 0) |
| | | (0, 0, 1, 1) | | | | | (0, 0, 0, 0) |
| | | (1, 0, 0, 0) | | | | | (0, 0, 0, 2) |
| | | (1, 0, 1, 0) | | | | | (1, 0, 1, 1) |
| 20/30 | (0, 1, 0, 1) | (0, 1, 0, 0) | N/A | (0, 1, 0, 1) | (0, 1, 0, 0) | N/A | (0, 1, 0, 1) |
| 21/31 | (0, 2, 0, 1) | (0, 2, 0, 0) | N/A | (0, 2, 0, 1) | (0, 2, 0, 0) | N/A | (0, 2, 0, 1) |
| 22/32 | (0, 1, 1, 1) | (0, 1, 1, 0) | N/A | N/A | N/A | N/A | (0, 1, 1, 0) |
| 23/33 | (0, 0, 0, 1) | (0, 0, 0, 0) | N/A | (0, 0, 0, 1) | (0, 0, 0, 0) | N/A | (0, 0, 0, 1) |
| 24/34 | (0, 0, 1, 1) | (0, 0, 1, 0) | N/A | N/A | N/A | N/A | (0, 0, 1, 0) |
| 25/35 | (0, 0, 0, 1) | (0, 0, 0, 0) | N/A | (0, 0, 0, 1) | (0, 0, 0, 0) | N/A | (0, 0, 0, 1) |
| | (0, 0, 1, 1) | (0, 0, 1, 0) | | (1, 0, 0, 1) | (1, 0, 0, 0) | | (0, 0, 1, 0) |
| 26/36 | (0, 0, 0, 1) | (0, 0, 0, 0) | N/A | (0, 0, 0, 1) | (0, 0, 0, 0) | N/A | (0, 0, 0, 1) |
| | (0, 0, 1, 1) | (0, 0, 1, 0) | | (1, 0, 0, 1) | (1, 0, 0, 0) | | (0, 0, 1, 0) |
| | (1, 0, 0, 1) | (1, 0, 0, 0) | | (2, 0, 0, 1) | (2, 0, 0, 0) | | (1, 0, 0, 1) |
| 27/37 | (0, 0, 0, 1) | (0, 0, 0, 0) | N/A | (0, 0, 0, 1) | (0, 0, 0, 0) | N/A | (0, 0, 0, 1) |
| | (0, 0, 1, 1) | (0, 0, 1, 0) | | (1, 0, 0, 1) | (1, 0, 0, 0) | | (0, 0, 1, 0) |
| | (1, 0, 0, 1) | (1, 0, 0, 0) | | (2, 0, 0, 1) | (2, 0, 0, 0) | | (1, 0, 0, 1) |
| | (1, 0, 1, 1) | (1, 0, 1, 0) | | (3, 0, 0, 1) | (3, 0, 0, 0) | | (1, 0, 1, 0) |
| 28/38 | (0, 0, 0, 1) | (0, 0, 0, 0) | N/A | (0, 0, 0, 1) | (0, 0, 0, 0) | N/A | (0, 0, 0, 1) |
| | (0, 0, 1, 1) | (0, 0, 1, 0) | | (1, 0, 0, 1) | (1, 0, 0, 0) | | (0, 0, 1, 0) |
| | (1, 0, 0, 1) | (1, 0, 0, 0) | | (2, 0, 0, 1) | (2, 0, 0, 0) | | (1, 0, 0, 1) |
| | (1, 0, 1, 1) | (1, 0, 1, 0) | | (3, 0, 0, 1) | (3, 0, 0, 0) | | (1, 0, 1, 0) |
| | (2, 0, 0, 1) | (2, 0, 0, 0) | | (4, 0, 0, 1) | (4, 0, 0, 0) | | (2, 0, 0, 1) |
| 29/39 | (0, 0, 0, 1) | (0, 0, 0, 0) | N/A | (0, 0, 0, 1) | (0, 0, 0, 0) | N/A | (0, 0, 0, 1) |
| | (0, 0, 1, 1) | (0, 0, 1, 0) | | (1, 0, 0, 1) | (1, 0, 0, 0) | | (0, 0, 1, 0) |
| | (1, 0, 0, 1) | (1, 0, 0, 0) | | (2, 0, 0, 1) | (2, 0, 0, 0) | | (1, 0, 0, 1) |
| | (1, 0, 1, 1) | (1, 0, 1, 0) | | (3, 0, 0, 1) | (3, 0, 0, 0) | | (1, 0, 1, 0) |
| | (2, 0, 0, 1) | (2, 0, 0, 0) | | (4, 0, 0, 1) | (4, 0, 0, 0) | | (2, 0, 0, 1) |
| | (2, 0, 1, 1) | (2, 0, 1, 0) | | (5, 0, 0, 1) | (5, 0, 0, 0) | | (2, 0, 1, 0) |
| 40 | (0, 1, 0, 0) | N/A | N/A | (0, 1, 0, 0) | N/A | N/A | (0, 1, 0, 0) |
| 41 | (0, 2, 0, 0) | N/A | N/A | (0, 2, 0, 0) | N/A | N/A | (0, 2, 0, 0) |
| 42 | (0, 1, 1, 0) | N/A | N/A | N/A | N/A | N/A | N/A |
| 43 | (0, 0, 0, 0) | N/A | N/A | (0, 0, 0, 0) | N/A | N/A | (0, 0, 0, 0) |
| 44 | (0, 0, 1, 0) | N/A | N/A | N/A | N/A | N/A | N/A |
| 45 | (0, 0, 0, 0) | N/A | N/A | (0, 0, 0, 0) | N/A | N/A | (0, 0, 0, 0) |
| | (0, 0, 1, 0) | | | (1, 0, 0, 0) | | | (1, 0, 0, 0) |
| 46 | (0, 0, 0, 0) | N/A | N/A | (0, 0, 0, 0) | N/A | N/A | (0, 0, 0, 0) |
| | (0, 0, 1, 0) | | | (1, 0, 0, 0) | | | (1, 0, 0, 0) |
| | (1, 0, 0, 0) | | | (2, 0, 0, 0) | | | (2, 0, 0, 0) |
| 47 | (0, 0, 0, 0) | N/A | N/A | (0, 0, 0, 0) | N/A | N/A | (0, 0, 0, 0) |
| | (0, 0, 1, 0) | | | (1, 0, 0, 0) | | | (1, 0, 0, 0) |
| | (1, 0, 0, 0) | | | (2, 0, 0, 0) | | | (2, 0, 0, 0) |
| | (1, 0, 1, 0) | | | (3, 0, 0, 0) | | | (3, 0, 0, 0) |
| 48 | (0, 1, 0, *) | (0, 1, 0, *) | (0, 1, 0, *) | (0, 1, 0, *) | (0, 1, 0, *) | (0, 1, 0, *) | (0, 1, 0, *) |
| 49 | (0, 2, 0, *) | (0, 2, 0, *) | (0, 2, 0, *) | (0, 2, 0, *) | (0, 2, 0, *) | (0, 2, 0, *) | (0, 2, 0, *) |
| 50 | (0, 1, 1, *) | (0, 1, 1, *) | (0, 1, 1, *) | N/A | N/A | N/A | (0, 1, 1, *) |
| 51 | (0, 0, 0, *) | (0, 0, 0, *) | (0, 0, 0, *) | (0, 0, 0, *) | (0, 0, 0, *) | (0, 0, 0, *) | (0, 0, 0, *) |
| 52 | (0, 0, 1, *) | (0, 0, 1, *) | (0, 0, 1, *) | N/A | N/A | N/A | (0, 0, 1, *) |
| 53 | (0, 0, 0, *) | (0, 0, 0, *) | (0, 0, 0, *) | (0, 0, 0, *) | (0, 0, 0, *) | (0, 0, 0, *) | (0, 0, 0, *) |
| | (0, 0, 1, *) | (0, 0, 1, *) | (0, 0, 1, *) | (1, 0, 0, *) | (1, 0, 0, *) | (1, 0, 0, *) | (0, 0, 1, *) |
| 54 | (0, 0, 0, *) | (0, 0, 0, *) | (0, 0, 0, *) | (0, 0, 0, *) | (0, 0, 0, *) | (0, 0, 0, *) | (0, 0, 0, *) |
| | (0, 0, 1, *) | (0, 0, 1, *) | (0, 0, 1, *) | (1, 0, 0, *) | (1, 0, 0, *) | (1, 0, 0, *) | (0, 0, 1, *) |
| | (1, 0, 0, *) | (1, 0, 0, *) | (1, 0, 0, *) | (2, 0, 0, *) | (2, 0, 0, *) | (2, 0, 0, *) | (1, 0, 0, *) |
| 55 | (0, 0, 0, *) | (0, 0, 0, *) | (0, 0, 0, *) | (0, 0, 0, *) | (0, 0, 0, *) | (0, 0, 0, *) | (0, 0, 0, *) |
| | (0, 0, 1, *) | (0, 0, 1, *) | (0, 0, 1, *) | (1, 0, 0, *) | (1, 0, 0, *) | (1, 0, 0, *) | (0, 0, 1, *) |
| | (1, 0, 0, *) | (1, 0, 0, *) | (1, 0, 0, *) | (2, 0, 0, *) | (2, 0, 0, *) | (2, 0, 0, *) | (1, 0, 0, *) |
| | (1, 0, 1, *) | (1, 0, 1, *) | (1, 0, 1, *) | (3, 0, 0, *) | (3, 0, 0, *) | (3, 0, 0, *) | (1, 0, 1, *) |
| 56 | (0, 0, 0, *) | (0, 0, 0, *) | (0, 0, 0, *) | (0, 0, 0, *) | (0, 0, 0, *) | (0, 0, 0, *) | (0, 0, 0, *) |
| | (0, 0, 1, *) | (0, 0, 1, *) | (0, 0, 1, *) | (1, 0, 0, *) | (1, 0, 0, *) | (1, 0, 0, *) | (0, 0, 1, *) |
| | (1, 0, 0, *) | (1, 0, 0, *) | (1, 0, 0, *) | (2, 0, 0, *) | (2, 0, 0, *) | (2, 0, 0, *) | (1, 0, 0, *) |
| | (1, 0, 1, *) | (1, 0, 1, *) | (1, 0, 1, *) | (3, 0, 0, *) | (3, 0, 0, *) | (3, 0, 0, *) | (1, 0, 1, *) |
| | (2, 0, 0, *) | (2, 0, 0, *) | (2, 0, 0, *) | (4, 0, 0, *) | (4, 0, 0, *) | (4, 0, 0, *) | (2, 0, 0, *) |
| 57 | (0, 0, 0, *) | (0, 0, 0, *) | (0, 0, 0, *) | (0, 0, 0, *) | (0, 0, 0, *) | (0, 0, 0, *) | (0, 0, 0, *) |
| | (0, 0, 1, *) | (0, 0, 1, *) | (0, 0, 1, *) | (1, 0, 0, *) | (1, 0, 0, *) | (1, 0, 0, *) | (0, 0, 1, *) |
| | (1, 0, 0, *) | (1, 0, 0, *) | (1, 0, 0, *) | (2, 0, 0, *) | (2, 0, 0, *) | (2, 0, 0, *) | (1, 0, 0, *) |
| | (1, 0, 1, *) | (1, 0, 1, *) | (1, 0, 1, *) | (3, 0, 0, *) | (3, 0, 0, *) | (3, 0, 0, *) | (1, 0, 1, *) |
| | (2, 0, 0, *) | (2, 0, 0, *) | (2, 0, 0, *) | (4, 0, 0, *) | (4, 0, 0, *) | (4, 0, 0, *) | (2, 0, 0, *) |
| | (2, 0, 1, *) | (2, 0, 1, *) | (2, 0, 1, *) | (5, 0, 0, *) | (5, 0, 0, *) | (5, 0, 0, *) | (2, 0, 1, *) |

From Table 5, it may be seen that when the resource of the time domain is not enough to configure PRACH channels through time division multiplexing, a plurality of PRACH channels will have a same time domain location. In this case, frequency division multiplexing will be adopted at this time domain location to map these PRACH channels. In an ordinary uplink subframe, the frequency domain mapping method for frequency-domain-multiplexing PRACH channels is to map from the two sides of the frequency band to its middle to ensure the PRACH channels have certain space in the frequency domain and possesses diversity gain. The mapping method is shown in Formula (1). For the random access channels in the UpPTS, the frequency-domain-multiplexing PRACH channels between two UpPTSs is mapped alternately in the upper and lower sidebands of the frequency band, while in each UpPTS, a plurality of the frequency-domain PRACH channels are continuously mapped to the lower sideband or upper sideband of the frequency band. The mapping method is shown in Formula (2).

$$\begin{matrix}{n}_{PRB}^{RA} = \{ \begin{matrix}{n}_{PRB offset}^{RA} + 6 ⌊ \frac{{f}_{RA}}{2} ⌋ , & if {f}_{RA} mod 2 = 0 \\ {N}_{RB}^{UL} - 6 - {n}_{PRB offset}^{RA} - 6 ⌊ \frac{{f}_{RA}}{2} ⌋ , & otherwise\end{matrix} & ( 1 ) \\ {n}_{PRB}^{RA} = \{ \begin{matrix}6 {f}_{RA} , & if ( ( {n}_{f} mod 2 ) \times ( 2 - {N}_{SP} ) + {t}_{RA}^{1} ) mod 2 = 0 \\ {N}_{RB}^{UL} - 6 ( {f}_{RA} + 1 ) , & otherwise\end{matrix} & ( 2 )\end{matrix}$$

Wherein, n_{PRB offset}^{RA} is the initial frequency domain location of the PRACH channel; N_{RB}^{UL} is the total number of RBs to which the configuration of uplink system bandwidth corresponds; f_{RA} is the frequency domain index of the PRACH channels with a same time domain location; └ ┘ denotes downward rounding. n_{f} is a system frame number. N_{SP} is the number of the downlink-to-uplink switch-points in a radio frame.

According to the embodiments of the present invention, firstly a method for allocating the dedicated random access resource is provided. It is applied in non-contention random access and used to allocate the dedicated random access preamble to the UE, and allocate the PRACH to which the dedicated random access preamble corresponds.

FIG. 4 is a flow chart of the method for allocating the dedicated random access resource according to the embodiment of the present invention. As shown in FIG. 4, the method for allocating the dedicated random access resource according to the embodiment of the present invention mainly includes the following steps:

step S401: the base station allocates the dedicated random access preamble to the UE, and allocates the predetermined PRACH to which the dedicated random access preamble corresponds in this radio frame; and

step S403: the base station transmits signaling to the UE, which includes the time domain information and the frequency domain information of the predetermined PRACH.

Below the foregoing steps are further described in details.

(I) Step S401

In the specific implementation process, in step S401, the base station may allocate the predetermined PRACH to which the dedicated random access preamble corresponds by five allocation methods. Before the five allocation methods are described, related concepts that the embodiment of the present invention involves will be introduced at first.

PRACH-time slot: a time window, L (L is a natural number above 0) continuous uplink subframes or an UpPTS that the PRACH (or called random access opportunity, or random access resource) occupies in the time domain. The L continuous uplink subframes constitute a PRACH-time slot, or this UpPTS is a PRACH-time slot.

In each PRACH-time slot, one or a plurality of PRACH channels may be multiplexed in frequency domain.

Supposing there are M foregoing PRACH-time slots in the radio frame. The M PRACH-time slots will be numbered according to the size of the time domain, as m=0, 1, . . . , M−1; in the M PRACH-time slots, there are N PRACH channels in total, N>=M.

The general policy for allocation of the predetermined PRACH channels (the dedicated random access resource) in the embodiment of the present invention is that: in a same PRACH-time slot, each UE is allocated at most one dedicated random access resource, i.e. in a same PRACH-time slot, the base station allocates the dedicated random access preamble of a certain UE in one frequency domain of the PRACH channel at most; in different PRACH-time slots, the frequency domain location of the dedicated random access resource allocated to a same UE may be different, i.e. the base station may allocate the dedicated random access preamble to a same UE on the PRACH channel of different frequency domain locations.

Below the five allocation methods are described separately.

Allocation Method 1

In this allocation method, the dedicated random access preamble that the base station allocates to a certain UE is format 0, or 1, or 3, and the dedicated random access resource of this UE is reserved in M′ (1<M′≦M) continuous PRACH-time slots with the serial number m starting from 0. In other words, the base station acquires M′ continuous PRACH-time slots with serial number starting from 0 in the current radio frame, and regards a PRACH in each of the M′ PRACH-time slots as the PRACH to which the dedicated random access preamble corresponds.

Specifically, there may be the following two realization methods:

1) In the PRACH-time slot with serial number m=0, the base station regards the PRACH channel with frequency domain index=0 (i.e. the PRACH channel with f_{RA}=0 in this PRACH-time slot, also called the first PRACH channel in this PRACH-time slot) as the PRACH channel to which the dedicated random access preamble allocated to the UE corresponds, i.e. the dedicated random access preamble that the base station allocates to the UE corresponds to the first PRACH channel (i.e. the PRACH channel with f_{RA}=0 in this PRACH-time slot); in PRACH-time slot m (0<m≦M′), when the number of the frequency-domain-multiplexing PRACH channels is greater than 1 and the dedicated random access preamble of this UE in PRACH-time slot (m−1) corresponds to the first PRACH channel, the base station will regard the PRACH channel with frequency domain index=1 in PRACH-time slot m (i.e. the second PRACH channel of PRACH-time slot m) as the PRACH channel to which the dedicated random access preamble of this UE corresponds, i.e. the dedicated random access preamble the base station allocates to this UE corresponds to the second PRACH channel in PRACH-time slot m (i.e. the PRACH channel with f_{RA}=1 in this PRACH-time slot). Otherwise, the dedicated random access preamble that the base station allocates to this UE will still correspond to the first PRACH channel.

2) In the PRACH-time slot with serial number m=0, the base station regards the PRACH channel with frequency domain index=1 (i.e. the PRACH channel with f_{RA}=1 in this PRACH-time slot, also called the second PRACH channel in this PRACH-time slot) as the PRACH channel to which the dedicated random access preamble allocated to the UE corresponds, i.e. the dedicated random access preamble the base station allocates to the UE corresponds to the second PRACH channel (i.e. the PRACH channel with f_{RA}=0 in this PRACH-time slot); in PRACH-time slot m (0<m≦M′), when the number of the frequency-domain-multiplexing PRACH channels is greater than 1 and the dedicated random access preamble of this UE in PRACH-time slot (m−1) corresponds to the first PRACH channel, the base station will regard the PRACH channel with frequency domain index=1 in PRACH-time slot m (i.e. the second PRACH channel of PRACH-time slot m) as the PRACH channel to which the dedicated random access preamble of this UE corresponds, i.e. the dedicated random access preamble the base station allocates to this UE corresponds to the second PRACH channel of PRACH-time slot m (i.e. the PRACH channel with f_{RA}=1 in this PRACH-time slot). Otherwise, the dedicated random access preamble the base station allocates to this UE will still correspond to the first PRACH channel.

Allocation Method 2

In this allocation method, the dedicated random access preamble that the base station allocates to a certain UE reserves the dedicated random access resource of this UE in all of the M (M>1) PRACH-time slots, i.e. the base station regards the PRACH with a same frequency domain index in each PRACH-time slot of the radio frame as the predetermined PRACH.

Specifically, the base station may regard the PRACH channels with frequency domain index=0 or 1 or 2 in each PRACH-time slot of the radio frame (i.e. the first, second or third PRACH channels) as the PRACH channels to which the dedicated random access preamble allocated to the UE corresponds. In other words, the dedicated random access preamble the base station allocates to the UE corresponds to the first PRACH channel of each PRACH-time slot (i.e. the PRACH with f_{RA}=0), or the second PRACH channel of each PRACH-time slot (i.e. the PRACH with f_{RA}=1), or the third PRACH channel of each PRACH-time slot.

Allocation Method 3

In this allocation method, the dedicated random access preamble that the base station allocates to a certain UE is reserved only in one PRACH-time slot of the radio frame, i.e. the base station regards a PRACH in the radio frame as the PRACH channel to which the dedicated random access preamble allocated to this UE corresponds.

Specifically, the base station may number all PRACH channels in the radio frame according to a preset rule, and then select a PRACH channel with a corresponding serial number as the PRACH channel to which the dedicated random access preamble allocated to this UE corresponds.

In other words, the base station allocates the dedicated random access preamble allocated to the UE to the n^{th} PRACH channel of N PRACH channels in the radio frame, wherein N is the total number of the PRACH channels in M PRACH-time slots. The N PRACH channels may be pre-numbered according to the preset rule.

Wherein, the foregoing N PRACH channels may be numbered according to the following rule: start from the frequency-domain-multiplexing PRACH channels in the first PRACH-time slot according to the rule of first frequency domain then time domain, and number the channels till the frequency-domain-multiplexing PRACH channels in the last PRACH-time slot. The numbering sequence of the frequency-domain-multiplexing PRACH in each PRACH-time slot is same as the frequency domain mapping sequence of the PRACH (i.e. according to the size of f_{RA}); or the PRACH channels are numbered from the lower sideband to the upper sideband of the frequency band according to their locations in the frequency domain (i.e. according to the size of n_{PRB}^{RA}). Alternatively, the N PRACH channels may be numbered according to the rule of first time domain then frequency domain.

Allocation Method 4

In this allocation method, the base station numbers the PRACH-time slots in the radio frame and then selects the PRACH channel with a same frequency domain index f_{RA} in odd or even PRACH-time slots as the PRACH channel to which the dedicated random access preamble allocated to the UE corresponds.

In other words, the base station allocates the dedicated random access preambles with format=0, 1 or 3 for the PRACH channels with a same frequency domain index f in all even PRACH-time slots to a certain UE; alternatively, the base station allocates the dedicated random access preambles with format=0, 1 or 3 for the PRACH channels with a same frequency domain index f_{RA} in all odd PRACH-time slots to a certain UE.

Allocation Method 5

In this allocation method, the base station numbers the PRACH channels in the radio frame at first. Specifically, the PRACH in the frequency domain of each PRACH-time slot in this radio frame may be numbered according to its mapping sequence in the frequency domain (i.e. according to the size of f_{RA}); alternatively the PRACH in the frequency domain of each PRACH-time slot may also be numbered according to its absolute location in the frequency domain; and

then, the base station selects a PRACH channel in a specific PRACH frequency band of the first PRACH-time slot as an initial PRACH channel, and then repeats the following operation in the radio frame: proceed from the just selected PRACH channel, and select the PRACH channel with the next serial number if the next PRACH-time slot exists and the PRACH channel with the next serial number exists in the frequency domain of this PRACH-time slot; otherwise select the PRACH channel of the first frequency band (i.e. frequency domain index is 0) in this PRACH-time slot. All the selected PRACH channels form a set. This set is called PRACH resource combination. The dedicated random access preamble that the base station allocates to a certain UE may correspond to all PRACH channels included into a resource combination, i.e. the base station regards all PRACH channels included into this resource combination as the PRACH channels (i.e. the foregoing predetermined PRACH channels) to which the dedicated random access preamble allocated to the UE corresponds.

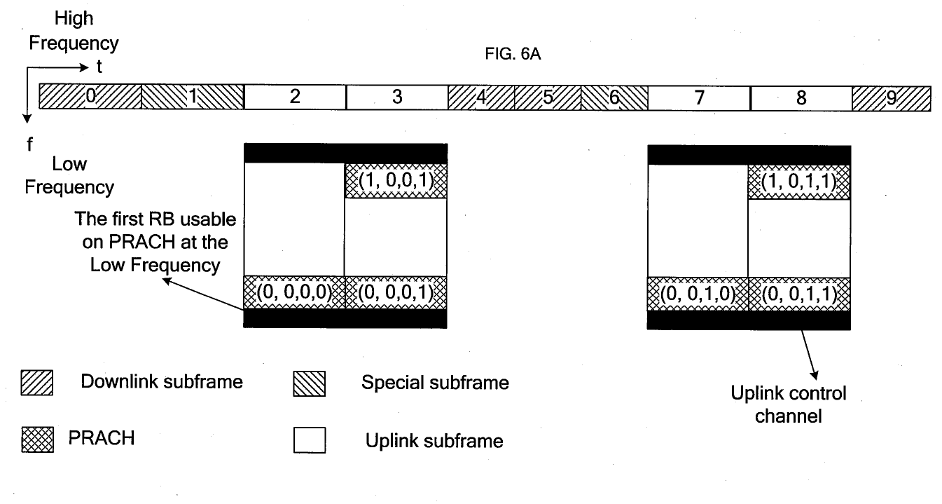

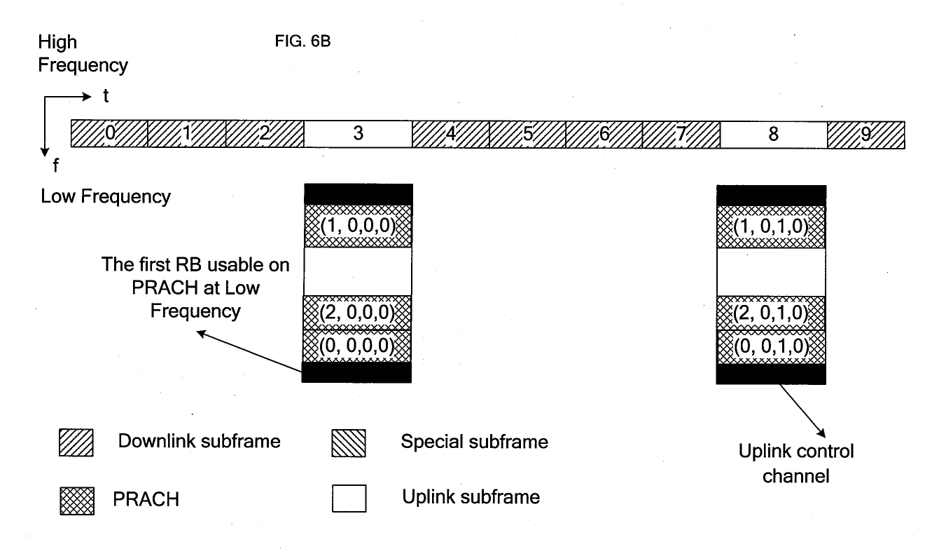

For example, if the current locations of the time-frequency domain of PRACH channels are (0,0,0,0), (1,0,0,0), (2,0,0,0), (0,0,1,0), (1,0,1,0) and (2,0,1,0) as shown in FIG. 6B, there are 2 PRACH-time slots in total, i.e. M=2, and each PRACH-time slot has 3 PRACH channels and the mapping sequence of PRACH channels in the frequency domain is adopted, i.e. the sequence of PRACH frequency band f_{RA} is {0, 1, 2, 3, 4, 5}. If the location of the selected initial PRACH channel is (0,0,0,0) and the frequency band f_{RA}=0, then the PRACH at location (1,0,1,0) will correspond to the next PRACH-time slot and f_{RA}=1, so the selection condition is met and a PRACH resource combination is obtained, i.e. PRACH(0,0,0,0) and PRACH(1,0,1,0).

For the same reason, there are two other combinations: PRACH(2,0,0,0), PRACH(0,0,1,0); and PRACH(1,0,0,0), PRACH(2,0,1,0).

The base station provided by the embodiment of the present invention may provide different allocation methods for different UEs, so the flexibility of the allocation of dedicated random access resource may be enhanced.

(II) Step S403

In a specific implementation process, step S403 may be realized by the following method:

1) The base station and the UE prearrange the correspondence between the dedicated random access resource allocation index and the dedicated random access resource; the details may be as shown in Tables 6, 7 and 8 below.

2) The base station acquires the dedicated random access resource allocation index corresponding to the PRACH channel (i.e. the dedicated random access resource) to which the current dedicated random access preamble allocated to the UE corresponds.

3) The base station transmits signaling to this UE; the signaling includes the dedicated random access resource allocation index acquired above.

After receiving the foregoing signaling, the UE may acquire the dedicated random access resource allocation index from the signaling, and then acquires the dedicated random access resource to which the dedicated random access resource allocation index corresponds according to the prearranged correspondence between the dedicated random access resource allocation index and the dedicated random access resource, and initiates a non-contention based random access in this dedicated random access resource.

According to the foregoing method provided by the embodiment of the present invention, different random access resources may be provided for different UEs, and a same dedicated random access preamble may be allocated to different UEs in the same time through allocating different PRACH channels to the dedicated random access preambles allocated to different UEs.

To further illustrate the foregoing method provided by the embodiment of the present invention, the specific realization of the random access by using the technical solution provided by the embodiment of the present invention in the LTE TDD system will be described below.

Non-contention based random access procedure is mainly used for the realization of handover and for the arrival of downlink data when the uplink of the UE is out of synchronism:

handover: the target cell generates a handover command; through the handover command transmitted from the source base station, the UE acquires the dedicated random access preamble information used in the target cell; and

the downlink data have arrived, but the UE is in out-of-synchronism state: through PDCCH, the UE acquires the allocated dedicated random access preamble.

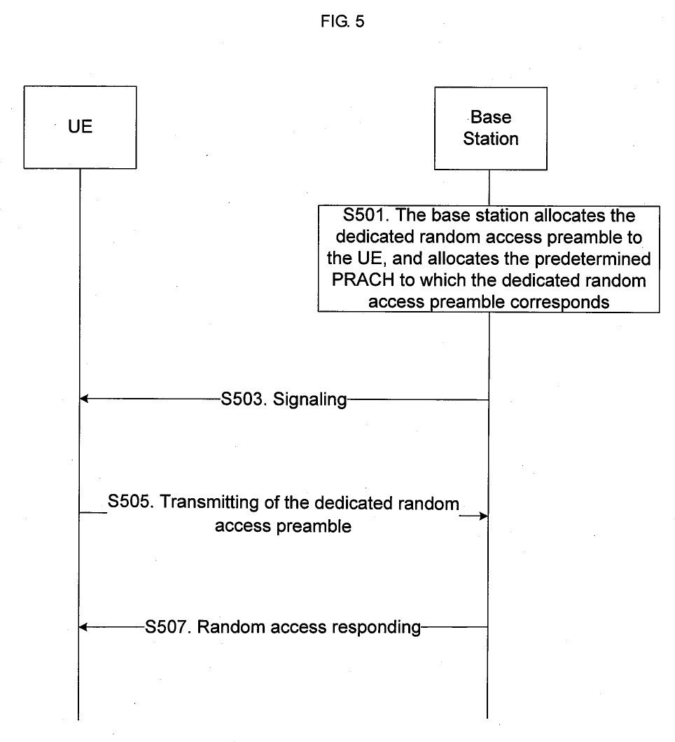

The non-contention based random access flow is shown in FIG. 5 and mainly includes the following steps:

step S501: the base station allocates the dedicated random access preamble to the UE, and allocates the PRACH channel to which the dedicated random access preamble corresponds;

step S503: the base station transmits signaling to the UE; the signaling includes the allocated dedicated random access preamble and allocation information; the allocation information is intended to indicate one or a plurality of specific PRACH channels in the radio frame, to which the dedicated random access preamble that the UE acquires corresponds;

step S505: the UE transmits the dedicated random access preamble over an uplink PRACH channel; and

step S507: the UE receives the random access response message from the base station on a downlink shared channel.

For easy description, quaternion (f_{RA}, t_{RA}⁰, t_{RA}¹, t_{RA}²) is used to express a specific PRACH in the LTE TDD system. f_{RA} stands for the frequency-domain-multiplexing PRACH index (the first PRACH channel corresponds to f_{RA}=0) in each PRACH-time slot, and t_{RA}⁰=0, 1, 2 is the radio frame where the PRACH-time slot locates, 0 stands for each of all radio frames, 1 stands for even radio frames and 2 stands for odd radio frames; t_{RA}¹=0, 1 stands for the half frame where the PRACH-time slot locates, wherein 0 stands for the first half frame and 1 stands for the second half frame; t_{RA}² indicates PRACH-time slot is UpPTS when it is (*); other values of t_{RA}² indicate that which uplink subframe in a half frame is the first subframe occupied by the PRACH-time slot.

### Embodiment 1

This embodiment describes non-contention random access of the UE by taking handover for example. While the UE acquires the dedicated random access preamble from a handover command, i.e. RRC Connection Reconfiguration message, it may also acquire the allocation information from the handover command. This allocation message is used to indicate which PRACH channel or which PRACH channels in the radio frame the dedicated random access preamble acquired by the UE corresponds to. This allocation message indicates one of many types of predetermined dedicated random access resource allocation. In specific implementation process, this allocation information may use 4-bit codes to indicate 16 types of resource allocation in the LTE TDD system, wherein, each code point is a dedicated random access resource allocation index, and corresponds to one or one group of the PRACH channels that may be used by the UE to transmit the dedicated random access preamble acquired by the UE. Table 6 provides a typical application of the method for allocating dedicated random access resource in the embodiment of the present invention. The 4-bit allocation index information provides 15 types of dedicated random access resource mapping (i.e. the correspondence between the foregoing dedicated random access resource allocation index and the dedicated random access resource). In Table 6, three allocation methods provided by the embodiment of the present invention are applied, namely: the foregoing allocation method 1, allocation method 2 and allocation method 3. Through this 4-bit allocation index information, the base station may flexibly allocate the respective dedicated access resource of the UE.

Further, the UE may also acquire the information about the random access configuration of the target cell and the information about uplink and downlink proportional configuration from the handover command in the same time, thereby the UE may acquire the time-frequency domain locations of PRACH channel of a target cell, so as to accurately determine the dedicated random access resource allocated to the UE.

TABLE 6
Dedicated random resource allocation table of the LTE TDD

| Dedicated random | |
|---|---|
| access resource | |
| allocation index | Mapping of dedicated random access resource (PRACH |
| (RA-Resource Index) | resource) |
| 0000 | the pre-numbered first PPACH channel in the radio frame |
| | (allocation method 3) |
| 0001 | the pre-numbered second PPACH channel in the radio frame |
| | (allocation method 3) |
| 0010 | the pre-numbered third PPACH channel in the radio frame |
| | (allocation method 3) |
| 0011 | the pre-numbered fourth PPACH channel in the radio frame |
| | (allocation method 3) |
| 0100 | the pre-numbered fifth PPACH channel in the radio frame |
| | (allocation method 3) |
| 0101 | the pre-numbered sixth PPACH channel in the radio frame |
| | (allocation method 3) |
| 0110 | the PRACH channel with f_{RA} = 0 in frequency domain of |
| | “PRACH-time slot” 0 and the PRACH channel with f_{RA} = 1 in |
| | the frequency domain of “PRACH-time slot” 1 (allocation |
| | method 1, M′ = 2) |
| 0111 | The PRACH channel with f_{RA} = 1 in the frequency domain of |
| | “PRACH-time slot” 0 and the PRACH channel with f_{RA} = 0 in |
| | the frequency domain of “PRACH-time slot” 1 (allocation |
| | method 1, M′ = 2) |
| 1000 | The PRACH channel with f_{RA} = 0 in the frequency domain of |
| | “PRACH-time slot” 0, the PRACH channel with f_{RA} = 1 in the |
| | frequency domain of “PRACH-time slot” 1 and the PRACH |
| | channel with f_{RA} = 0 in the frequency domain of |
| | “PRACH-time slot” 2 |
| | (allocation method 1, M′ = 3) |
| 1001 | The PRACH channel with f_{RA} = 1 in the frequency domain of |
| | “PRACH-time slot” 0, the PRACH channel with f_{RA} = 0 in the |
| | frequency domain of “PRACH-time slot” 1 and the PRACH |
| | channel with f_{RA} = 1 in the frequency domain of |
| | “PRACH-time slot” 2 |
| | (allocation method 1, M′ = 3) |
| 1010 | The PRACH channel with f_{RA} = 1 in the frequency domain of |
| | “PRACH-time slot” 0, the PRACH channel with f_{RA} = 0 in the |
| | frequency domain of “PRACH-time slot” 1, the PRACH |
| | channel with f_{RA} = 1 in the frequency domain of |
| | “PRACH-time slot” 2 and the PRACH channel with f_{RA} = 0 in |
| | the frequency domain of “PRACH-time slot” 3 |
| | (allocation method 1 of the present invention, M′ = 4) |
| 1011 | The PRACH channel with f_{RA} = 0 in the frequency domain of |
| | “PRACH-time slot” 0, the PRACH channel with f_{RA} = 1 in the |
| | frequency domain of “PRACH-time slot” 1, the PRACH |
| | channel with f_{RA} = 0 in the frequency domain of |
| | “PRACH-time slot” 2 and the PRACH channel with f_{RA} = 1 in |
| | the frequency domain of “PRACH-time slot” 3 |
| | (allocation method 1, M′ = 4) |
| 1100 | The PRACH channels with f_{RA} = 0 in the frequency domain |
| | of all “PRACH-time slots” (allocation method 2) |
| 1101 | The PRACH channels with f_{RA} = 1 in the frequency domain |
| | of all “PRACH-time slots” (allocation method 2) |
| 1110 | The PRACH channels with f_{RA} = 2 in the frequency domain |
| | of all “PRACH-time slots” (allocation method 2) |
| 1111 | Reserved extension bit |

The application of Table 6 in the LTE TDD system is described with specific examples:

If the PRACH configuration index of the target cell that the UE acquires through a handover command is 18 (See Table 4) and the uplink and downlink proportional configuration is 1, then the UE will acquire the locations of the time domain and the frequency domain of the PRACH are (0,0,0,1), (0,0,1,1), (0,0,0,0), (0,0,1,0), (1,0,0,1) and (1,0,1,1). As shown in FIG. 6A, there are 4 PRACH-time slots in total, i.e. M=4. In these 4 PRACH-time slots, there are 6 PRACH channels in total, i.e. N=6; when the allocation message the UE acquires from the handover command indicates the dedicated random access resource allocation index is 1011, the UE may acquire the dedicated random access preamble that the base station allocates to it corresponds to the following 4 PRACH channels, and the UE may initiate a non-contention based random access on these 4 PRACH channels:

the first PRACH channel of subframe 2 (corresponding to f_{RA}=0, i.e. (0,0,0,0));

the second PRACH channel of subframe 3 (corresponding to f_{RA}=1, i.e. (1,0,0,1));

the first PRACH channel of subframe 7 (corresponding to f_{RA}=0, i.e. (0,0,1,0)); and

the second PRACH channel of subframe 8 (corresponding to f_{RA}=1, i.e. (1,0,1,1)).

If the PRACH configuration index of the target cell that the UE acquires through a handover command is 18 (See Table 4) and the uplink and downlink proportional configuration is 2, then the UE will acquire the locations of the time domain and the frequency domain of the PRACH are (0,0,0,0), (1,0,0,0), (2,0,0,0), (0,0,1,0), (1,0,1,0) and (2,0,1,0). As shown in FIG. 6B, there are 2 PRACH-time slots in total, i.e. M=2. In these 2 PRACH-time slots, there are 6 PRACH channels in total, i.e. N=6; when the allocation message the UE acquires from the handover command indicates the dedicated random access resource allocation index is 0110, the UE may acquire the dedicated random access preamble that the base station allocates to it corresponds to the following 2 PRACH channels, and the UE may initiate a non-contention based random access over these 2 PRACH channels:

the first PRACH channel of subframe 3 (corresponding to f_{RA}=0, i.e. (0,0,0,0)); and

the second PRACH channel of subframe 8 (corresponding to f_{RA}=1, i.e. (1,0,1,0)).

When the allocation message the UE acquires from the handover command indicates the dedicated random access resource allocation index is 0111, the UE may acquire the dedicated random access preamble that the base station allocates to it corresponds to the following 2 PRACH channels, and the UE may initiate a non-contention based random access over these 2 PRACH channels:

the second PRACH channel of subframe 3 (corresponding to f_{RA}=1, i.e. (1,0,0,0)); and

the first PRACH channel of subframe 8 (corresponding to f_{RA}=0, i.e. (0,0,1,0)).

When the allocation message the UE acquires from the handover command indicates the dedicated random access resource allocation index is 1110, the UE may acquire the dedicated random access preamble that the base station allocates to it corresponds to the following 2 PRACH channels, and the UE may initiate a non-contention based random access over these 2 PRACH channels:

the third PRACH channel of subframe 3 (corresponding to f_{RA}=2, i.e. (2,0,0,0)); and

the third PRACH channel of subframe 8 (corresponding to f_{RA}=2, i.e. (2,0,1,0)).

In addition to Table 6, there are also two typical applications containing the method for allocating dedicated random access resource provided by the embodiment of the present invention, as shown in Table 7 and Table 8; what is different from Table 6, Table 7 adds the foregoing allocation method 4 and deletes two types of resource mapping that apply allocation method 1, while Table 8 adds the resource mapping of the foregoing allocation method 5.

TABLE 7
Dedicated random resource allocation table of the LTE TDD

| RA-Resource | |
|---|---|
| Index | Mapping of dedicated random access resource (PRACH resource) |
| 0000 | The pre-numbered first PPACH channel in the radio frame (allocation |
| | method 3) |
| 0001 | The pre-numbered second PPACH channel in the radio frame |
| | (allocation method 3) |
| 0010 | The pre-numbered third PPACH channel in the radio frame |
| | (allocation method 3) |
| 0011 | The pre-numbered fourth PPACH channel in the radio frame |
| | (allocation method 3) |
| 0100 | The pre-numbered fifth PPACH channel in the radio frame (allocation |
| | method 3) |
| 0101 | The pre-numbered sixth PPACH channel in the radio frame |
| | (allocation method 3) |
| 0110 | The PRACH channel with f_{RA} = 0 in the frequency domain of |
| | “PRACH-time slot” 0 and the PRACH channel with f_{RA} = 1 in the |
| | frequency domain of “PRACH-time slot” 1 |
| | (allocation method 1, M′ = 2) |
| 0111 | The PRACH channel with f_{RA} = 1 in the frequency domain of |
| | “PRACH-time slot” 0 and the PRACH channel with f_{RA} = 0 in the |
| | frequency domain of “PRACH-time slot” 1 |
| | (allocation method 1, M′ = 2) |
| 1000 | The PRACH channel with f_{RA} = 0 in the frequency domain of |
| | “PRACH-time slot” 0, the PRACH channel with f_{RA} = 1 in the |
| | frequency domain of “PRACH-time slot” 1 and the PRACH channel |
| | with f_{RA} = 0 in the frequency domain of “PRACH-time slot” 2 |
| | (allocation method 1, M′ = 3) |
| 1001 | The PRACH channel with f_{RA} = 1 in the frequency domain of |
| | “PRACH-time slot” 0, the PRACH channel with f_{RA} = 0 in the |
| | frequency domain of “PRACH-time slot” 1 and the PRACH channel |
| | with f_{RA} = 1 in the frequency domain of “PRACH-time slot” 2 |
| | (allocation method 1, M′ = 3) |
| 1010 | The PRACH channels with f_{RA} = 0 in the frequency domain of all |
| | even “PRACH-time slots” (allocation method 4) |
| 1011 | The PRACH channels with f_{RA} = 0 in the frequency domain of all |
| | odd “PRACH-time slots” (allocation method 4) |
| 1100 | The PRACH channels with f_{RA} = 0 in the frequency domain of all |
| | “PRACH-time slots” (allocation method 2) |
| 1101 | The PRACH channel with f_{RA} = 1 in the frequency domain of all |
| | “PRACH-time slots” (allocation method 2) |
| 1110 | The PRACH channel with f_{RA} = 2 in the frequency domain of all |
| | “PRACH-time slots” (allocation method 2) |
| 1111 | Reserved extension bit |

TABLE 8
Dedicated random resource allocation table of the LTE TDD

| RA-Resource | |
|---|---|
| Index | Mapping of dedicated random access resource (PRACH resource) |
| 0000 | The pre-numbered first PPACH channel in the radio frame |
| | (allocation method 3) |
| 0001 | The pre-numbered second PPACH channel in the radio frame |
| | (allocation method 3) |
| 0010 | The pre-numbered third PPACH channel in the radio frame |
| | (allocation method 3) |
| 0011 | The pre-numbered fourth PPACH channel in the radio frame |
| | (allocation method 3) |
| 0100 | The pre-numbered fifth PRACH channel in the radio frame |
| | (allocation method 3) |
| 0101 | The pre-numbered sixth PPACH channel in the radio frame |
| | (allocation method 3) |
| 0110 | The PRACH channels with f_{RA} = 0 in the frequency domain of all |
| | “PRACH-time slots” (allocation method 2) |
| 0111 | The PRACH channel with f_{RA} = 1 in the frequency domain of all |
| | “PRACH-time slots” (allocation method 2) |
| 1000 | The PRACH channel with f_{RA} = 2 in the frequency domain of all |
| | “PRACH-time slots” (allocation method 2) |
| 1001 | The initial PRACH channel with f_{RA} = 0 (allocation method 5) |
| 1010 | The initial PRACH channel with f_{RA} = 1 (allocation method 5) |
| 1011 | The initial PRACH channel with f_{RA} = 2 (allocation method 5) |
| 1100 | The PRACH channels with f_{RA} = 0 in all even “PRACH-time |
| | slots” (allocation method 4) |
| 1101 | The PRACH channels with f_{RA} = 0 in all odd “PRACH-time |
| | slots” (allocation method 4) |
| 1110 | The PRACH channels with f_{RA} = 1 in all even “PRACH-time slots” |
| | (allocation method 4) |
| 1111 | The PRACH channels with f_{RA} = 1 in all odd “PRACH-time |
| | slots” (allocation method 4) |

### Embodiment 2

When downlink data have arrived, but the UE is in uplink out-of-synchronism state, the UE will acquire the dedicated random access preamble from PDCCH and meanwhile will acquire allocation information from the downlink signaling to determine which PRACH channel or which PRACH channels in the radio frame the dedicated random access preamble the UE acquires corresponds to. This allocation message indicates one of many types of predetermined dedicated random access resource allocation. When system bandwidth is large and the number of the configured PRACH channels is large, the resource allocation Table 6 or Table 7 for the purpose of handover in Embodiment 1 may be adopted, and 4-bit codes are used to inform the UE one type of resource mapping in the table; when system bandwidth is small, 2-bit codes may be adopted to indicate 4 types of resource allocation, which may be a subset of Table 6 or Table 7.

The specific implementation process is similar to Embodiment 1 and is not described here.

According to the embodiment of the present invention, a base station is also provided. This base station may realize the foregoing method for allocating dedicated random access resource.

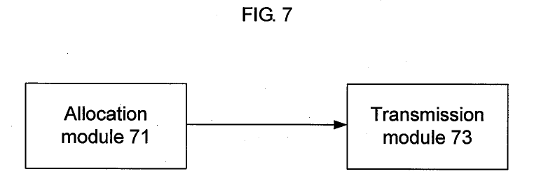

FIG. 7 is a block diagram illustrating the structure of a base station according to the embodiment of the present invention. As shown in FIG. 7, the base station according to the embodiment of the present invention mainly comprises: an allocation module 71 and a transmission module 73 connected to the allocation module 71. The allocation module 71 is used to allocate the dedicated random access preamble to the UE, and allocate the PRACH to which the dedicated random access preamble corresponds; the transmission module 73 is connected to the allocation module 71, and used to transmit signaling to the UE, wherein, the signaling includes the time domain information and the frequency domain information of the PRACH channel allocated above.

As the PRACH to which the dedicated random access preamble corresponds has five allocation methods in specific implementation process, the corresponding allocation module 71 may comprise 5 sub-modules, which are intended to allocate the PRACH to which the dedicated random access preamble corresponds by the foregoing five allocation methods, respectively.

Further, in actual application, the allocated PRACH may be expressed with the dedicated random access resource allocation table according to the prearranged correspondence between dedicated random access resource allocation index and dedicated random access resource. Therefore, the transmission module 73 only needs to transmit the random access resource allocation index to which the allocated PRACH corresponds to the UE. The UE may acquire from this index which PRACH channel or which PRACH channels are allocated.

Through the foregoing base station provided by the embodiment of the present invention, PRACH channels can be flexibly allocated to the UE.

As described above, with the help of the technical solution provided by the embodiment of the present invention, the dedicated random access resource allocated to a certain UE may be configured flexibly, and through transmitting the location of the PRACH to which the allocated dedicated random access preamble corresponds to the UE, different UEs may use a same dedicated random access preamble on different PRACH channels, thereby increasing the chance of using non-contention based random access procedure and raising the utilization efficiency of the dedicated random access preamble; moreover, when the base station allocates the dedicated random access preamble to the UE, the dedicated random access preamble allocated through dedicated signaling configuration may be transmitted over a plurality of PRACH channels in the time domain of the radio frame, so that after random access is failed, random access can be initiated soon, thereby shortening delay.

The foregoing descriptions are preferred embodiments of the present invention and are not intended to limit the present invention. For those skilled in the art, the present invention may have various changes and modifications. All modifications, identical replacements and improvements made without departing from the spirit and principle of the present invention shall be within the protection scope of the present invention.

What is claimed is:

1. A method for allocating the dedicated random access resource, including:
a base station allocating a dedicated random access preamble to a UE, and allocating a predetermined PRACH to which the dedicated random access preamble corresponds in a radio frame; and
the base station transmitting signaling to the UE, wherein the signaling includes time domain information and frequency domain information of the predetermined PRACH.

2. The method of claim 1, wherein the base station allocating the PRACH to which the dedicated random access preamble corresponds, specifically includes:
step 1, the base station acquires M′ continuous PRACH-time slots with serial number m starting from 0 in the radio frame;
step 2, the base station regards a PRACH of each of the M′ PRACH-time slots in the frequency domain as the predetermined PRACH, wherein,
the PRACH-time slots are L continuous uplink subframes that the PRACH occupies in the time domain, L is a natural number and L≧1; or the PRACH-time slot is an uplink pilot time slot that the PRACH occupies in the time domain; and
M′ is a natural number and 1<M′≦M, and M is the total number of PRACH-time slots in the radio frame; the PRACH-time slots in the radio frame are numbered in advanced by starting from 0 according to a sequence of time domains.

3. The method of claim 2, wherein the step 2 specifically includes:
in the PRACH-time slot with serial number m=0, the base station regards the PRACH with frequency domain index=0 as the predetermined PRACH; and
in the PRACH-time slot with serial number 0<m≦M′, when the predetermined condition is met, the base station will regard the PRACH with frequency domain index=1 in the m^{th} PRACH-time slot as the predetermined PRACH, otherwise it will regard the PRACH with frequency domain index=0 in the m^{th} PRACH-time slot as the predetermined PRACH; wherein, the predetermined condition is that the number of the current frequency-domain-multiplexing PRACH channels is greater than 1, and the base station regards the PRACH with frequency domain index=0 in the (m−1)^{th} PRACH-time slot as the predetermined PRACH.

4. The method of claim 2, wherein the step 2 specifically includes:
in the PRACH-time slot with serial number m=0, the base station regards the PRACH with frequency domain index=1 as the predetermined PRACH; and
in the PRACH-time slot with serial number 0<m≦M′, when the predetermined condition is met, the base station will regard the PRACH with frequency domain index=1 in the m^{th} PRACH-time slot as the predetermined PRACH, otherwise it will regard the PRACH with frequency domain index=0 in the m^{th} PRACH-time slot as the predetermined PRACH; wherein, the predetermined condition is that the number of the current frequency-domain-multiplexing PRACH channels is greater than 1, and the base station regards the PRACH with frequency domain index=0 in the (m−1)^{th} PRACH-time slot as the predetermined PRACH.

5. The method of claim 1, wherein the base station allocating the predetermined PRACH to which the dedicated random access preamble corresponds, specifically includes:
the base station regards the PRACH with a same frequency domain index in each PRACH-time slot in the radio frame as the predetermined PRACH, wherein, the PRACH-time slots are L continuous uplink subframes that the PRACH occupies in the time domain, L is a natural number and L≧1; or the PRACH-time slot is an uplink pilot time slot that the PRACH occupies in the time domain.

6. The method of claim 1, wherein the base station allocating the PRACH to which the dedicated random access preamble corresponds to the UE, specifically includes:
the base station regards one PRACH in the radio frame as the predetermined PRACH.

7. The method of claim 6, wherein the base station regards a PRACH in the radio frame as the predetermined PRACH, specifically includes:
the base station numbers all PRACH channels in the radio frame according to the preset rule; and
the base station selects the PRACH with a serial number as the predetermined PRACH.

8. The method of claim 7, wherein the preset rule specifically is:
starting from the frequency-domain-multiplexing PRACH in the first PRACH-time slot according to the rule of first frequency domain then time domain, and numbering all frequency-domain-multiplexing PRACH channels in this time slot according to the mapping sequence of the PRACH channels in the frequency domain or according to the locations of the PRACH channels in the frequency domain, from the lower sideband to the upper sideband of the frequency band till the frequency-domain-multiplexing PRACH in the last PRACH-time slot; or
starting from the PRACH with the smallest frequency domain mapping index according to the rule of first time domain then frequency domain, and numbering the PRACH channels with a same frequency domain index according to the time sequence relation of PRACH-time slots till the PRACH with the largest frequency domain mapping index.

9. The method of claim 1, wherein the base station allocating the predetermined PRACH to which the dedicated random access preamble corresponds, specifically includes:
the base station numbers the PRACH-time slots in the radio frame; and
the base station selects the PRACH with a same frequency domain index in the odd or even PRACH-time slots as the predetermined PRACH.

10. The method of claim 1, wherein the base station allocating the predetermined PRACH to which the dedicated random access preamble corresponds, specifically includes:
the PRACH channels in the frequency domain of each PRACH-time slot in the radio frame are numbered according to their mapping sequence in the frequency domain, or according to their absolute locations in the frequency domain; and
a PRACH in the first PRACH-time slot in the radio frame is selected and regarded as an initial PRACH; the following operation is repeated in the radio frame: proceed from the just selected PRACH, and select the PRACH with a next serial number if the next PRACH-time slot exists and the PRACH with the next serial number exists in the frequency domain of this PRACH-time slot; otherwise the PRACH with frequency domain index=0 in this PRACH-time slot will be selected.

11. The method of claim 1, wherein the base station transmitting the signaling to the UE, specifically includes:
the base station acquires the dedicated random access resource index to which the allocated predetermined PRACH corresponds according to the prearranged correspondence between dedicated random access resource allocation index and dedicated random access resource; and
the base station transmits the signaling which includes the acquired dedicated random access resource allocation index to the UE.

12. The method of claim 11, wherein after the base station transmits the signaling which includes the acquired dedicated random access resource allocation index to the UE, the method further includes:
the UE acquires the dedicated random access resource allocation index from the signaling; and
the UE acquires the dedicated random access resource to which the dedicated random access resource allocation index corresponds according to the correspondence between dedicated random access resource allocation index and dedicated random access resource, which is prearranged with the base station, and initiates a non-contention based random access in this dedicated random access resource.

13. A base station, comprising:
an allocation module, used to allocate a dedicated random access preamble to a UE, and allocate a PRACH to which the dedicated random access preamble corresponds; and
a transmission module, used to transmit signaling to the UE, wherein, the signaling includes time domain information and frequency domain information of the PRACH.
